(19) United States
(12) Patent Application Publication
(10) Pub. No.: US 2024/0364111 A1
(43) Pub. Date: Oct. 31, 2024

(54) METHOD AND SYSTEM FOR ENERGY STORAGE POWER STATION CAPACITY MULTI-OBJECTIVE OPTIMIZATION CONFIGURATION ADAPTING TO VARIABLE ENERGY STORAGE PERIOD

(71) Applicant: CHANGSHA UNIVERSITY, Changsha City (CN)

(72) Inventor: Bo YANG, Changsha City (CN)

(21) Appl. No.: 18/635,780

(22) Filed: Apr. 15, 2024

(30) Foreign Application Priority Data
Apr. 17, 2023 (CN) 202310412602.7

(51) Int. Cl. H02J 3/28

(52) U.S. Cl. CPC H02J 3/28; H02J 2203/20; H02J 2300/22; H02J 2300/28

(57) ABSTRACT

The application relates to a method and a system for energy storage power station capacity multi-objective optimization configuration adapting to variable energy storage period: firstly, obtaining a load power curve and a conventional energy power generation output curve from a power dispatching system to obtain a new energy power generation net demand curve; then calculating the optimization configuration capacity of energy storage power stations in the energy storage period and the planning period duration; calculating the opportunity carbon costs and energy storage power station capacity investment costs under different energy storage power station capacities in the planning period duration, and constructing the opportunity carbon cost function and energy storage power station capacity investment cost function, so as to construct a multi-objective energy storage power station capacity optimization configuration model, and calculate a multi-objective Pareto optimization set.

### CROSS-REFERENCE TO RELATED APPLICATIONS

This application claims priority to Chinese Patent Application No. 202310412602.7, filed on Apr. 17, 2023, the contents of which are hereby incorporated by reference.

### TECHNICAL FIELD

The application belongs to the technical field of low-carbon power system, and particularly relates to a method and a system for energy storage power station capacity multi-objective optimization configuration adapting to variable energy storage period.

### BACKGROUND

Low-carbon power system is related to China's energy green and low-carbon transformation development and stable economic and social development. In order to realize low-carbon power system, on the one hand, it is necessary to reduce thermal power generation with high carbon emissions as much as possible at the energy supply end, and increase the power generation by new energy sources such as wind and solar energy with low carbon or zero carbon emissions; on the other hand, it is necessary to ensure that the power system is capable of making power users at the energy consumption end to obtain reliable and stable electric energy under the high fluctuation and strong randomness of new energy power generation such as wind and solar energy. Therefore, energy storage has become an extremely important part of low-carbon power system. Electrochemical energy storage power stations, pumped storage power stations, photothermal power stations and other energy storage power stations are being planned and built on a large scale. The electrochemical energy storage power stations use battery components such as sodium ion batteries, lithium ion batteries and flow batteries, and the energy storage duration is generally less than 4 hours. Pumped storage power stations are the energy storage power stations with the largest capacity, the most mature technology, the best economy and the most large-scale development conditions, and the energy storage duration is more than 4 hours, even as high as several days or weeks. In the aspect of photothermal power station, molten salt heat storage and other technologies are used to store and release heat energy by using the temperature change, phase change or chemical reaction of the heat storage medium, which has the advantages of high heat storage density, stable working state and long heat storage time, so it is suitable for large-scale medium-high temperature heat storage, and a single machine may achieve a heat storage capacity of more than 100 MWh. Generally, it is used as a supporting energy storage facility for photothermal power generation to improve solar energy utilization, reduce power fluctuation and promote stable output of photothermal power station. At present, the research on the planning, design and operation scheduling of energy storage power stations has become the focus of national energy regulatory agencies, power dispatching agencies and energy storage power station operators.

The capacity configuration of energy storage power stations is closely related to the high volatility and strong randomness of new energy power generation such as wind power and solar energy, the energy storage duration and energy storage period, and is subject to the investment limit of energy storage power station operators. In China, the capacity configuration of energy storage power stations is mostly promoted by the government through policies or carried out by the operators of energy storage power stations according to the investment needs. There is no unified and effective decision-making method for the capacity configuration of energy storage power stations by national energy regulatory agencies, power dispatching agencies and operators of energy storage power stations.

### SUMMARY

The objective of the present application is to solve the above problems in the prior art, and to provide a a method and a system for energy storage power station capacity multi-objective optimization configuration adapting to variable energy storage period. Based on the load power curve, the new energy power generation output curve and the conventional energy power generation output curve provided by the power dispatching system, the optimization configuration capacity of the energy storage power station is obtained through the relationship among the new energy power generation net demand curve, the energy storage period and the planning period duration. Then, a multi-objective energy storage power station capacity optimization configuration model based on the opportunity carbon cost function and the energy storage power station capacity investment cost function is constructed, and a multi-objective Pareto optimization set is obtained. According to this optimization set, a multi-objective optimization decision of energy storage power station capacity adapting to the variable energy storage period may be made. This method provides a quantitative and accurate technical means for the capacity configuration of energy storage power stations, and solves the shortcomings of the current capacity configuration of energy storage power stations, such as strong subjectivity, lack of quantitative analysis support and only adapting to specific energy storage periods, and provides effective means and decision support for the energy storage power station capacity optimization configuration.

In order to achieve the above objectives, the present application provides the following technical scheme.

The application provides a method for energy storage power station capacity multi-objective optimization configuration adapting to a variable energy storage period, including following steps:
S1, obtaining a load power curve and a conventional energy power generation output curve from a power dispatching system;
the load power curve is recorded as P_{load}(t), t represents a time, t ϵ [0, tₘₐₓ], and tₘₐₓ is a maximum value of the t; P_{load}(t) has a daily periodicity and a weekly periodicity, where the daily periodicity is reflected in obvious characteristics of a peak period, a waist load period and a trough period in the load power curve, and the weekly periodicity is reflected in obvious characteristics of working days and non-working days in the load power curve; the conventional energy power generation output curve is recorded as P_{old}(t), including a hydropower output curve P_{hydro}(t), a thermal power output curve Pₜₕₑᵣₘ(t), and a nuclear power output curve P_{nuclear}(t); the relationship among the conventional energy power generation output curve and the hydropower output curve, the thermal power output curve and the nuclear power output curve is as follows:

$${P}_{o l d} ( t ) = {P}_{h y d r o} ( t ) + {P}_{t h e r m} ( t ) + {P}_{n u c l e a r} ( t ) ;$$

S2, obtaining a wind power generation output curve P_{wind}(t) and a solar power generation output curve Pₚᵥ(t) from the power dispatching system, and obtaining a new energy power generation output curve P_{new}(t);

$${P}_{n e w} ( t ) = {P}_{w i n d} ( t ) + {P}_{p v} ( t ) ;$$

S3, performing a calculation according to the load power curve and the conventional energy power generation output curve to obtain a new energy power generation net demand curve P_{demand}(t);

$${P}_{d e m a n d} ( t ) = {P}_{load} ( t ) - {P}_{hydro} ( t ) - {P}_{therm} ( t ) - {P}_{n u c l e a r} ( t ) .$$

The new energy power generation net demand curve represents the deficiency of load power after deducting the conventional energy power generation output. This deficiency is as follows:
(1) if the deficiency is capable of being fully provided by the wind power generation output and solar power generation output, it indicates that the wind power generation output and solar power has been fully absorbed by the power system, and the utilization rate of wind power and solar power is 100%.
(2) if the deficiency may not be fully provided by the wind power generation output and solar power generation output, it indicates that the energy storage power station capacity is insufficient, the wind power generation output and solar power may not be fully absorbed by the power system, and the wind power generation is abandoned and solar power generation is abandoned, and the utilization rate of wind power generation and solar power power generation is less than 100%.
S4, calculating an optimization configuration capacity of an energy storage power station in the energy storage period and in a planning period duration according to the new energy power generation output curve and the new energy power generation net demand curve, and details are as follows:
S4-1, calculating an optimization configuration capacity E_{T}_{₁} of an energy storage power station in a first energy storage period [0, T₁];
the energy storage period is denoted as T₁, T₁ ϵ [0, tₘₐₓ] and charging and discharging behaviors are existed in the energy storage period, and a total charging duration of the energy storage station is an energy storage duration; the planning period duration is nT₁, and n is a multiple of the energy storage period:

$$\{ \begin{matrix}n = ⌊ \frac{{t}_{max}}{{T}_{1}} ⌋ \\ {nT}_{1} \leq {t}_{max}\end{matrix} ,$$

where a symbol [·] stands for rounding down;
letting a maximum number of intersection points between the new energy power generation net demand curve P_{demand}(t) and the new energy power generation output curve P_{new}(t) in the first energy storage period [0, T₁] be iₘₐₓ^{T}^{₁}, and time axis coordinates of the intersection points are as follows:

$${t}_{{T}_{1} , 1} , {t}_{{T}_{1} , 2} , … , {t}_{{T}_{1} , i} , … , {t}_{{T}_{1} , {i}_{max}^{{T}_{1}}} ,$$

and satisfying:

$$0 < {t}_{{T}_{1} , 1} < {t}_{{T}_{1} , 2} < … < {t}_{{T}_{1} , i} < … < {t}_{{T}_{1} , {i}_{max}^{{T}_{1}}} \leq {T}_{1} ,$$

where i represents an intersection number of two curves in the first energy storage period [0, T₁], i=(1,2, . . . , iₘₐₓ^{T}^{₁});
calculating energy storage areas

$${S}_{{T}_{1} , 1} , {S}_{{T}_{1} , 2} , … , {S}_{{T}_{1} , i} , … , {S}_{{T}_{1} , {i}_{max}^{{T}_{1}} + 1}$$

in the intervals of

$$\begin{matrix}[ 0 , {t}_{{T}_{1} , 1} ] , [ {t}_{{T}_{1} , 1} , {t}_{{T}_{1} , 2} ] , [ {t}_{{T}_{1} , {i}_{max}^{{T}_{1}} - 1} , {t}_{{T}_{1} , {i}_{max}^{{T}_{1}}} ] and [ {t}_{{T}_{1} , {i}_{max}^{{T}_{1}}} , {T}_{1} ] respectively : \\ {S}_{{T}_{1} , 1} = {\int }_{0}^{{t}_{{T}_{1} , 1}} ( {P}_{n e w} ( t ) - {P}_{d e m a n d} ( t ) ) dt , \\ {S}_{{T}_{1} , 2} = {\int }_{{t}_{{T}_{1} , 1}}^{{t}_{{T}_{1} , 2}} ( {P}_{n e w} ( t ) - {P}_{d e m a n d} ( t ) ) dt , \\ … , \\ {S}_{{T}_{1} , i} = {\int }_{{t}_{{T}_{1} , i - 1}}^{{t}_{{T}_{1} , i}} ( {P}_{n e w} ( t ) - {P}_{d e m a n d} ( t ) ) dt , \\ … , \\ {S}_{{T}_{1} , {i}_{max}^{{T}_{1}} + 1} = {\int }_{{t}_{{T}_{1} , {i}_{max}^{{T}_{1}}}}^{{T}_{1}} ( {P}_{n e w} ( t ) - {P}_{d e m a n d} ( t ) ) d t ,\end{matrix}$$

and in the first energy storage period [0, T₁], ∫₀^{T}^{₁}(P_{new}(t)−P_{demand}(t)) dt≤0, indicating that the energy storage power station will complete a whole cycle of charging and discharging in the first energy storage period;
the optimization configuration capacity E_{T}_{₁} of the energy storage power station in the first energy storage period [0, T₁] is calculated as follows:

$${E}_{{T}_{1}} = {( - 1 )}^{α} \vert {S}_{{T}_{1} , 1} \vert + {( - 1 )}^{α} \vert {S}_{{T}_{1} , 2} \vert + … + {( - 1 )}^{α} \vert {S}_{{T}_{1} , i} \vert + … + {( - 1 )}^{α} \vert {S}_{{T}_{1} , {i}_{max}^{{T}_{1}} + 1} \vert$$

wherein a value of a is as follows:

$$α = \{ \begin{matrix}0 , & if {S}_{{T}_{1} , i} \geq 0 \\ 1 , & if {S}_{{T}_{1} , i} < 0\end{matrix} ;$$

S4-2, according to a method in S4-1, calculating an optimization configuration capacity E_{T}_{₂} of an energy storage power station in a second energy storage period [T₁, 2T₁], an optimization configuration capacity E_{T}_{₃} of an energy storage power station in a third energy storage period [2T₁, 3T₁], . . . , and an optimization configuration capacity E_{T}_{ₙ} of an energy storage power station in an n-th energy storage period [(n−1)T₁, nT₁] in sequence; and
S4-3, calculating the optimization configuration capacity E of the energy storage power station in the planning period duration:
E=max{E_{T}_{₁}, E_{T}_{₂}, . . . , E_{T}_{ₙ}},
where, a symbol max{·, . . . ,·,} represents to take a maximum value.
The optimization configuration capacity E of the energy storage power station in the planning period duration calculated here corresponds to the energy storage period T₁, so the optimization configuration capacity of the energy storage power station may be obtained by setting the energy storage period T₁ to different values according to the energy storage duration.
S5, calculating an investment cost of the optimization configuration capacity of the energy storage power station according to the optimization configuration capacity E of the energy storage power station in the planning period duration: when the optimization configuration capacity of the energy storage power station in the planning period duration [0, nT₁] is E and the investment cost of a unit capacity is ϵ, the investment cost C_{cap,E} of the optimization configuration capacity of the energy storage power station is calculated according to a following formula:

$${C}_{cap , E} = E * ϵ ;$$

S6, calculating opportunity carbon costs and energy storage power station capacity investment costs under different energy storage power station capacities in the planning period duration, and constructing an opportunity carbon cost function and an energy storage power station capacity investment cost function, and details are as follows:
S6-1, calculating the opportunity carbon cost C_{opp,T}_{₁} under an energy storage power station capacity E′ in the first energy storage period [0, T₁]; during a whole planning period duration, when the energy storage power station capacity is lower than the optimization configuration capacity of the energy storage power station, a wind power generation output and a solar power generation output are not capable of being fully absorbed by a power system, and wind power generation is abandoned and solar power generation is abandoned, and the opportunity carbon cost will generate at this time; assuming that a change value of the energy storage power station capacity relative to the optimization configuration capacity is ΔE, ΔE ϵ [0, E], the energy storage power station capacity E′ is calculated as follows:

$${E}^{′} = E - Δ E ,$$

under the energy storage power station capacity E′, an opportunity carbon cost C_{opp,T}_{₁} in the first energy storage period [0, T₁] is:

$${C}_{opp , {T}_{1}} = β \vert \vert {S}_{{T}_{1} , 1} \vert - {E}^{′} \vert + β \vert \vert {S}_{{T}_{1} , 2} \vert - {E}^{′} \vert + … + β \vert \vert {S}_{{T}_{1} , {i}_{max}^{{T}_{1}}} \vert - {E}^{′} \vert ,$$

wherein a value of β is as follows:

$$β = \{ \begin{matrix}1 , & if {S}_{{T}_{1} , i} \geq 0 \\ 0 , & if {S}_{{T}_{1} , i} < 0\end{matrix} ;$$

S6-2, according to a method in S6-1, calculating an opportunity carbon cost C_{opp,T}_{₂} under an energy storage power station capacity E′ in the second energy storage period [T₁, 2T₁], an opportunity carbon cost C_{opp,T}_{₃} under an energy storage power station capacity E′ in the third energy storage period [2T₁, 3T₁], . . . and an opportunity carbon cost C_{opp,T}_{ₙ} under an energy storage power station capacity E′ in the n-th energy storage period [(n−1)T₁, nT₁] in sequence;
S6-3, calculating the opportunity carbon cost C_{opp,E′} under the energy storage power station capacity E′ in the planning period duration:

$${C}_{opp , {E}^{′}} = ( {C}_{opp , {T}_{1}} + {C}_{opp , {T}_{2}} + … + {C}_{o p p , {T}_{n}} ) * ε ,$$

where ε is a carbon price corresponding to a unit electric quantity;
S6-4, calculating the investment cost C_{cap,E′}:C_{cap,E′}=E′*ϵ under the energy storage power station capacity E′; and
S6-5, changing ΔE to obtain opportunity carbon costs Cₒₚₚ and energy storage power station capacity investment costs C_{cap} under different energy storage power station capacities E″, and then obtaining an opportunity carbon cost function and an energy storage power station capacity investment cost function under different energy storage power station capacities E″ in the planning period duration:
   f(E″): E″ → Cₒₚₚ
   g(E″): E″ → C_{cap},
where f(E″) is the opportunity carbon cost function under different energy storage power station capacities E″, g(E″) is the energy storage power station capacity investment cost function under different energy storage power station capacities E″, and a symbol → represents a functional mapping relationship between the energy storage power station capacities E″ and the opportunity carbon costs Cₒₚₚ or the energy storage power station capacity investment costs C_{cap} under different energy storage power station capacities E″;
S7, constructing a multi-objective energy storage power station capacity optimization configuration model according to the opportunity carbon cost function and the energy storage power station capacity investment cost functions under different energy storage power station capacities E″ in the planning period duration, and calculating a multi-objective Pareto optimization set;
the multi-objective energy storage power station capacity optimization configuration model is as follows:
   min {f(E″),g(E″)}
   s.t. f(E″)≤Cₒₚₚ^{max}
g(E″)≤C_{cap}^{max},
where min{·,·} represents a minimization of the opportunity carbon cost function f(E″) and the energy storage power station capacity investment cost function g(E″), s.t. represents constraint conditions, Cₒₚₚ^{max} and C_{cap}^{max} represent a maximum of the opportunity carbon cost and a maximum of an energy storage power station capacity investment cost respectively; because f(E″) and g(E″) are mutually exclusive targets, a calculation result is a multi-objective Pareto optimization set Pₐᵣₑₜₒ;
The solution methods of the multi-objective energy storage power station capacity optimization configuration models are multi-objective optimization algorithms, including but not limited to multi-objective gradient descent algorithm, strength Pareto evolutionary algorithm (SPEA), multi-objective evolutionary algorithm based on decomposition (MOEA/D), non-dominated sorting genetic algorithm (NSGA) and so on. The multi-objective Pareto optimization set is obtained by calculation:
Pₐᵣₑₜₒ={E′_{opt,1}, E′_{opt,2}, . . . , E′_{opt,j}, . . . , E′_{opt,j}_{ₘₐₓ}},
where j is an element number in Pₐᵣₑₜₒ, jₘₐₓ is a maximum number of elements in Pₐᵣₑₜₒ, and E′_{opt,j} is a j-th element, namely a j-th energy storage power station multi-objective optimization capacity value in Pₐᵣₑₜₒ. At this time, there are jₘₐₓ multi-objective optimization capacity values in Pₐᵣₑₜₒ, and the ranking is automatically generated by multi-objective optimization algorithm, which may not be directly used for the decision of energy storage power station capacity optimization configuration.
S8, determining weights of elements in the multi-objective Pareto optimization set Pₐᵣₑₜₒ according to a fuzzy set function, and outputting an energy storage power station multi-objective optimization capacity value in order according to the weights from large to small; this result provides a decision support for an energy storage power station capacity optimization configuration: the fuzzy set function is defined as follows:

$${η}_{f} ( {E}_{o p t , j}^{′} ) = \{ \begin{matrix}0 , & f ( {E}_{o p t , j}^{′} ) \leq {γ}_{f} \\ \frac{f ( {E}_{opt , j}^{′} ) - {γ}_{f}}{{ρ}_{f} - {γ}_{f}} , & {γ}_{f} < f ( {E}_{o p t , j}^{′} ) < {ρ}_{f} \\ 1 , & f ( {E}_{o p t , j}^{′} ) > {ρ}_{f}\end{matrix} ,$$

$${η}_{g} ( {E}_{o p t , j}^{′} ) = \{ \begin{matrix}0 , & g ( {E}_{o p t , j}^{′} ) \leq {γ}_{g} \\ \frac{g ( {E}_{opt , j}^{′} ) - {γ}_{g}}{{ρ}_{g} - {γ}_{g}} , & {γ}_{g} < g ( {E}_{o p t , j}^{′} ) < {ρ}_{g} \\ 1 , & g ( {E}_{o p t , j}^{′} ) \geq {ρ}_{g}\end{matrix} ,$$

where ρ_{f} and γ_{f} are upper and lower limits of opportunity carbon cost thresholds respectively, and values of ρ_{f} and γ_{f} are determined by energy storage power station capacity optimization configurators according to opportunity carbon cost requirements, and γ_{f}<ρ_{f}, ρ_{g} and γ_{g} are upper and lower limits of energy storage power station capacity investment cost thresholds respectively, and values of ρ_{g} and γ_{g} are determined by the energy storage power station capacity optimization configurators according to capacity investment cost requirements, and γ_{g}<ρ_{g}, η_{f}(E′_{opt,j}) is a fuzzy set function of the opportunity carbon cost of a j-th element E′_{opt,j} in the Pₐᵣₑₜₒ, and η_{g}(E′_{opt,j}) is a fuzzy set function of the energy storage power station capacity investment cost of the j-th element E′_{opt,j} in the Pₐᵣₑₜₒ, and the values of η_{f}(E′_{opt,j}) and η_{g}(E′_{opt,j}) are all between 0 and 1.

The weight ηⱼ of the j-th element E′_{opt,j} in Pₐᵣₑₜₒ is calculated according to the following formula:

$${η}_{j} = \frac{{η}_{f} ( {E}_{opt , j}^{′} ) + {η}_{g} ( {E}_{opt , j}^{′} )}{{\sum }_{j = 1}^{{j}_{max}} ( {η}_{f} ( {E}_{opt , j}^{′} ) + {η}_{g} ( {E}_{opt , j}^{′} ) )} .$$

According to the weight ηⱼ, the multi-objective optimization capacity values of the energy storage power station are sequentially output from large to small, and this result provides decision support for the optimization capacity configuration of the energy storage power station.

The application also provides a system for the energy storage power station capacity multi-objective optimization configuration adapting to the variable energy storage period, including a basic data extraction module, a new energy power generation net demand curve generation module, an energy storage power station capacity optimization configuration model construction module, an energy storage power station capacity optimization configuration model solving module and a system output module;
the basic data extraction module is used to obtain load power curve, conventional energy power generation output curve (including hydropower output curve, thermal power output curve and nuclear power output curve), wind power generation output curve, solar power generation output curve, etc. from the power dispatching system;
the new energy power generation net demand curve generation module is used for performing a calculation according to the load power curve and the conventional energy power generation output curve to obtain the new energy power generation net demand curve;
the energy storage power station capacity optimization configuration model construction module is used for calculating the optimization configuration capacity and the investment cost of the energy storage power station in the energy storage period and the planning period duration according to the new energy power generation output curve and the new energy power generation net demand curve; calculating the opportunity carbon costs and the energy storage power station capacity investment costs under different energy storage power station capacities in the planning period duration; constructing the opportunity carbon cost function and energy storage power station capacity investment cost function; constructing a multi-objective energy storage power station capacity optimization configuration model;
the energy storage power station capacity optimization configuration model solving module is used for solving the multi-objective energy storage power station capacity optimization configuration model and performing a calculation to obtain the multi-objective Pareto optimization set, and solving methods are the multi-objective optimization algorithms, including multi-objective gradient descent algorithm, strength Pareto evolutionary algorithm (SPEA), multi-objective evolutionary algorithm based on decomposition (MOEA/D) and non-dominated sorting genetic algorithm (NSGA); and
the system output module is used for determining the weights of the elements in the multi-objective Pareto optimization set according to the fuzzy set function, and then sequentially outputting energy storage power station capacity optimization configuration results according to the weights from large to small.

Each module above in the multi-objective optimization configuration system of the energy storage power station capacity adapting to the variable energy storage period is capable of being realized by softwares, hardwares and combinations thereof in whole or in part.

Each module above is capable of being embedded in or independent of a processor in a computer device in a hardware form, or is capable of being stored in a memory in the computer device in a software form, so as to facilitate the processor to call and execute operations corresponding to all the modules.

Compared with the prior art, the application has the following beneficial effects.

First, the influence of energy storage period is considered in the energy storage power station capacity optimization configuration, so that the energy storage power station capacity optimization configuration may adapt to different energy storage periods (such as a day, some days or some weeks) and different energy storage durations (such as short, medium and long-term energy storage), which provides a universal method for the energy storage power station capacity optimization configuration under different energy storage periods and different energy storage durations, realizes the energy storage power station capacity multi-objective optimization configuration with variable energy storage periods, and overcomes the limitation that the existing capacity optimization configuration method of energy storage power station is only suitable for specific energy storage duration or specific energy storage period.

Second, the influence of opportunity carbon cost and energy storage power station capacity investment cost is considered in the energy storage power station capacity optimization configuration, and the multi-objective energy storage power station capacity optimization configuration model is constructed, which takes the multi-objective Pareto optimization set as the decision-making basis, overcomes the limitation that the existing energy storage power station capacity optimization configuration is only based on a single objective, and enables the decision-makers of energy storage power station capacity optimization to make more reasonable decisions weighing multiple costs;

Third, the uncertainty of decision-making is considered in the energy storage power station capacity optimization configuration. By introducing the threshold value of opportunity carbon cost and the threshold value of energy storage power station capacity investment cost, a fuzzy set function is constructed, and the multi-objective optimization capacity values of energy storage power stations are output in order according to the weights of Pareto optimization set elements, which is convenient for the operators of energy storage power stations to make decisions.

Therefore, the application realizes the energy storage power station capacity multi-objective optimization configuration by weighing the opportunity carbon cost and the energy storage power station capacity investment cost, and provides effective methods and decision support for the energy storage power station capacity optimization configuration.

### BRIEF DESCRIPTION OF THE DRAWINGS

FIG. 1 is a flow chart of a method for energy storage power station capacity multi-objective optimization configuration adapting to a variable energy storage period in the present application.

FIG. 2 is a schematic diagram of the relationship among energy storage duration, energy storage period and planning period duration in the present application.

FIG. 3 is a schematic diagram of the relationship between the new energy power generation output curve and the new energy power generation net demand curve in the present application.

FIG. 4 is a structural diagram of a system for the energy storage power station capacity multi-objective optimization configuration adapting to the variable energy storage period in the present application.

### DETAILED DESCRIPTION OF THE EMBODIMENTS

The present application will be further described with reference to specific embodiments and drawings.

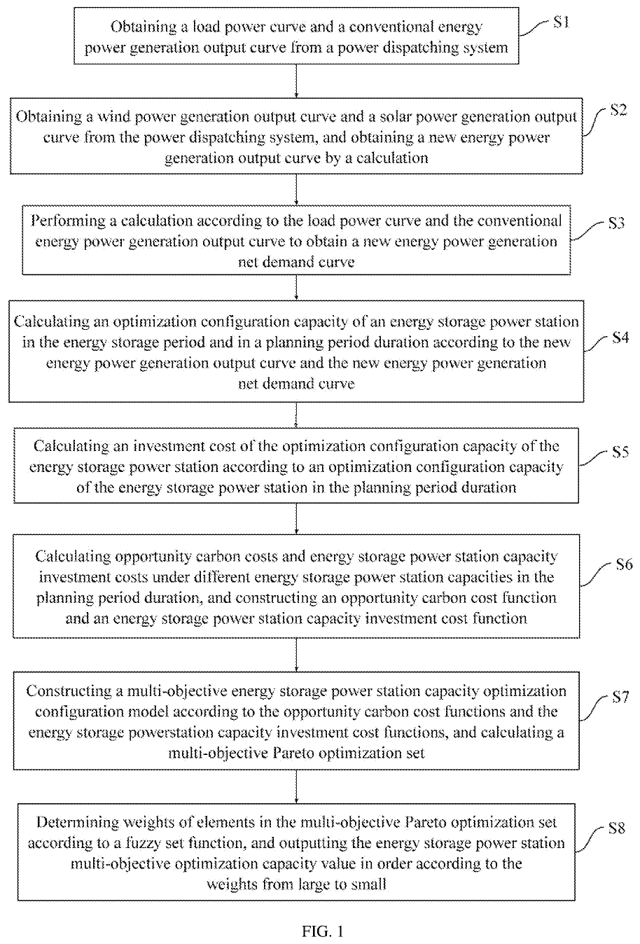

FIG. 1 is a flow chart of a method for energy storage power station capacity multi-objective optimization configuration adapting to a variable energy storage period in the present application.

S1, obtaining a load power curve and a conventional energy power generation output curve from a power dispatching system;

S2, obtaining a wind power generation output curve P_{wind}(t) and a solar power generation output curve Pₚᵥ(t) from the power dispatching system, and obtaining a new energy power generation output curve P_{new}(t);

S3, performing a calculation according to the load power curve and the conventional energy power generation output curve to obtain a new energy power generation net demand curve P_{demand}(t);

S4, calculating an optimization configuration capacity of an energy storage power station in the energy storage period and in a planning period duration according to the new energy power generation output curve and the new energy power generation net demand curve;

S5, calculating an investment cost of the optimization configuration capacity of the energy storage power station according to an optimization configuration capacity of the energy storage power station in the planning period duration;

S6, calculating opportunity carbon costs and energy storage power station capacity investment costs under different energy storage power station capacities in the planning period duration, and constructing an opportunity carbon cost function and an energy storage power station capacity investment cost function;

S7, constructing a multi-objective energy storage power station capacity optimization configuration model according to the opportunity carbon cost functions and the energy storage power station capacity investment cost functions under different energy storage power station capacities in the planning period duration, and calculating a multi-objective Pareto optimization set; and

S8, determining weights of elements in the multi-objective Pareto optimization set Pₐᵣₑₜₒaccording to a fuzzy set function, and outputting the energy storage power station multi-objective optimization capacity value in order according to the weights from large to small.

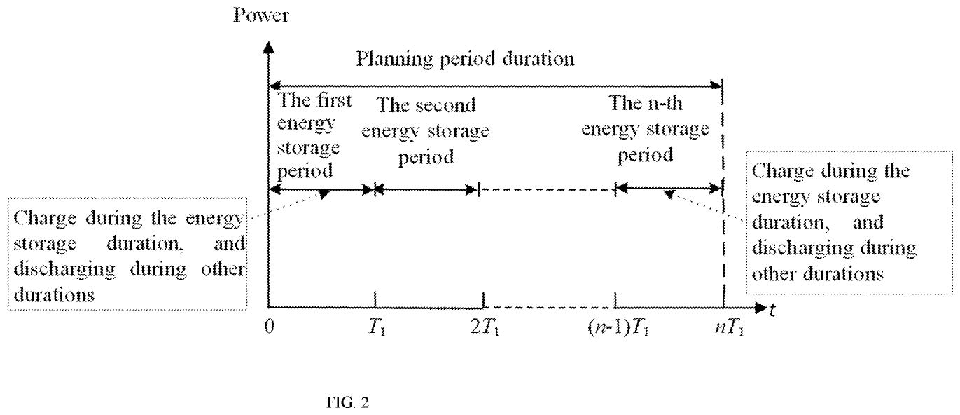

FIG. 2 is a schematic diagram of the relationship among energy storage duration, energy storage period and planning period duration in the present application. In the schematic diagram, the abscissa represents time t and the ordinate represents power. This coordinate graph is suitable for all kinds of power curves with power as the ordinate and time as the abscissa, including load power curve, conventional energy power generation output curve, wind power generation output curve, solar power generation output curve, new energy power generation output curve and new energy power generation net demand curve. In the drawing, the energy storage period is denoted as T₁, during the energy storage period, the energy storage power station has charging and discharging behaviors, and the total charging duration of the energy storage power station is the energy storage duration; the planning period duration is nT₁, and n is a multiple of the energy storage period. In each energy storage period (such as [0, T₁], [T₁, 2T₁], . . . , [(n−1)T₁, nT₁]), there is an optimization configuration capacity of the energy storage power station, and the energy storage power station may fully absorb the wind power generation output and solar power generation output in the power system under this optimization configuration capacity, that is, the utilization rate of wind power and solar power generation is 100%. If the energy storage power station capacity is below the optimization configuration capacity, it indicates that the capacity configuration of the energy storage power station is insufficient, and the wind power generation output and solar power generation output may not be fully absorbed by the power system, and there has been a abandonment of wind and light, which means that the utilization rate of wind power and solar power generation is less than 100%.

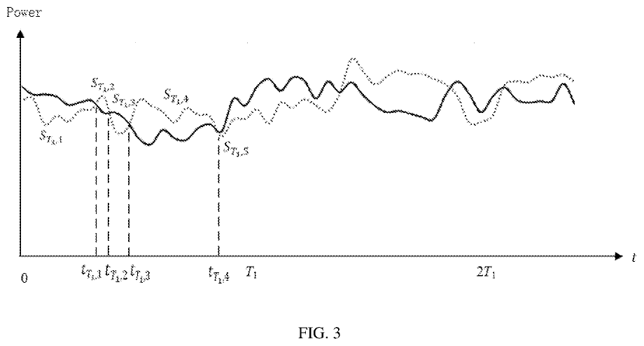

FIG. 3 is a schematic diagram of the relationship between the new energy power generation output curve and the new energy power generation net demand curve in the present application. In the drawing, the solid line represents the new energy power generation output curve P_{new}(t), the dotted line represents the new energy power generation net demand curve P_{demand}(t), the abscissa represents the time t, and the ordinate represents the power. The energy storage period is denoted as T₁, and there are charging and discharging behaviors in the energy storage power station during the energy storage period. In the first energy storage period [0, T₁], the maximum number iₘₐₓ^{T}^{₁} of intersections between the new energy power generation net demand curve and the new energy power generation output curve is 4, and the time axis coordinates of the intersections are:
t_{T}_{₁}_{,1}, t_{T}_{₁}_{,2}, t_{T}_{₁}_{,3}, t_{T}_{₁}_{,4},

and satisfying:
0<t_{T}_{₁}_{,1}<t_{T}_{₁}_{,2}<t_{T}_{₁}_{,3}<t_{T}_{₁}_{,4}≤T₁,

calculating energy storage areas of intervals of S_{T}_{₁}_{,1}, S_{T}_{₁}_{,2}, S_{T}_{₁}_{,3}, S_{T}_{₁}_{,4} and S_{T}_{₁}_{,5}in the intervals of [0, t_{T}_{₁}_{,1}], [t_{T}_{₁}_{,1}, t_{T}_{₁}_{,2}], . . . and [t_{T}_{₁}_{,4}, T₁]

$${S}_{{T}_{1} , 1} = {\int }_{0}^{{t}_{{T}_{1} , 1}} ( {P}_{n e w} ( t ) - {P}_{demand} ( t ) ) dt ,$$

$${S}_{{T}_{1} , 2} = {\int }_{{t}_{{T}_{1} , 1}}^{{t}_{{T}_{1} , 2}} ( {P}_{n e w} ( t ) - {P}_{demand} ( t ) ) dt ,$$

$${S}_{{T}_{1} , 3} = {\int }_{{t}_{{T}_{1} , 2}}^{{t}_{{T}_{1} , 3}} ( {P}_{n e w} ( t ) - {P}_{demand} ( t ) ) dt ,$$

$${S}_{{T}_{1} , 4} = {\int }_{{t}_{{T}_{1} , 3}}^{{t}_{{T}_{1} , 4}} ( {P}_{n e w} ( t ) - {P}_{demand} ( t ) ) dt ,$$

$${S}_{{T}_{1} , 5} = {\int }_{{t}_{{T}_{1} , 4}}^{{T}_{1}} ( {P}_{n e w} ( t ) - {P}_{demand} ( t ) ) dt .$$

Moreover, S_{T}_{₁}_{,1}, S_{T}_{₁}_{,3} and S_{T}_{₁}_{,5} are all greater than 0, indicating that the energy storage power station is charging in [0, t_{T}_{₁}_{,1}], [t_{T}_{₁}_{,2}, t_{T}_{₁}_{,3}] and [t_{T}_{₁}_{,4}, T₁]. Both S_{T}_{₁}_{,2} and S_{T}_{₁}_{,4} are less than 0, indicating that the energy storage power station discharges in the interval between [t_{T}_{₁}_{,1}, t_{T}_{₁}_{,2}] and [t_{T}_{₁}_{,3}, t_{T}_{₁}_{,4}].

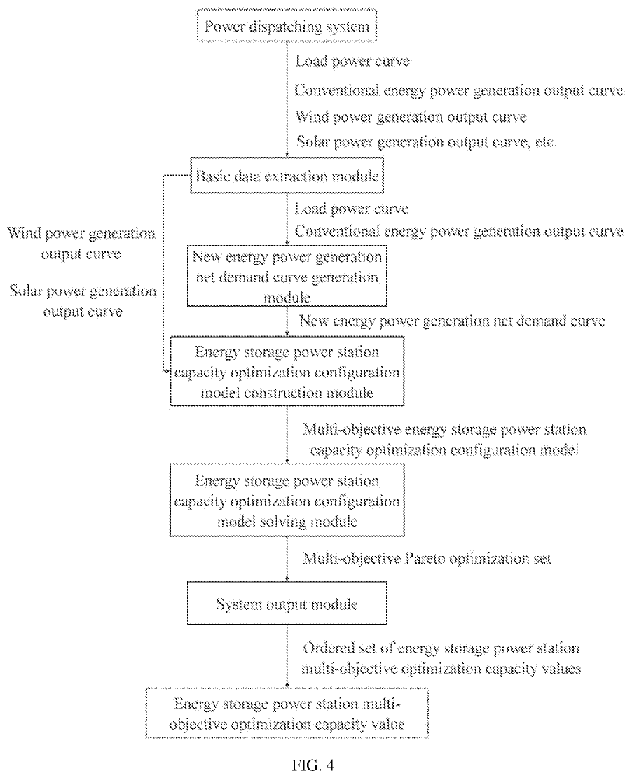

FIG. 4 is a structural diagram of a system for the energy storage power station capacity multi-objective optimization configuration adapting to the variable energy storage period in the present application. The system includes a basic data extraction module, a new energy power generation net demand curve generation module, an energy storage power station capacity optimization configuration model construction module, an energy storage power station capacity optimization configuration model solving module and a system output module and other modules. The basic data extraction module obtains basic data from the power dispatching system, including load power curve, conventional energy power generation output curve (including hydropower output curve, thermal power output curve and nuclear power output curve), wind power generation output curve, solar power generation output curve, etc. The new energy power generation net demand curve generation module is used for performing a calculation according to the load power curve and the conventional energy power generation output curve to obtain the new energy power generation net demand curve; the energy storage power station capacity optimization configuration model construction module is used for: \textcircled{1} calculating the optimization configuration capacity and the investment cost of energy storage power stations in the energy storage period and the planning period duration according to the new energy power generation output curve and the new energy power generation net demand curve; \textcircled{2} calculating the opportunity carbon costs and energy storage power station capacity investment costs under different energy storage power station capacities in the planning period duration, and constructing the opportunity carbon cost function and energy storage power station capacity investment cost function; \textcircled{3} constructing a multi-objective energy storage power station capacity optimization configuration model based on the opportunity carbon cost function and energy storage power station capacity investment cost function; the energy storage power station capacity optimization configuration model solving module is used to solve the multi-objective energy storage power station capacity optimization configuration model. The solving methods are multi-objective optimization algorithms, including multi-objective gradient descent algorithm, strength Pareto evolutionary algorithm (SPEA), multi-objective evolutionary algorithm based on decomposition (MOEA/D) and non-dominated sorting genetic algorithm (NSGA), etc., and finally a multi-objective Pareto optimization set is obtained through the calculation. The system output module is used to: \textcircled{1} determine the weights of elements in the multi-objective Pareto optimization set according to the fuzzy set function; (2) outputting the energy storage power station multi-objective optimization capacity values in order according to the weight from large to small.

1. A method for energy storage power station capacity multi-objective optimization configuration adapting to a variable energy storage period, comprising following steps:
S1, obtaining a load power curve and a conventional energy power generation output curve from a power dispatching system;
the load power curve is recorded as P_{load}(t), t represents a time, t ϵ [0, tₘₐₓ], and tₘₐₓ is a maximum value of the t; P_{load}(t) has a daily periodicity and a weekly periodicity, wherein the daily periodicity is reflected in a peak period, a waist load period and a trough period in the load power curve, and the weekly periodicity is reflected in working days and non-working days in the load power curve; the conventional energy power generation output curve is recorded as P_{old}(t), comprising a hydropower output curve P_{hydro}(t), a thermal power output curve Pₜₕₑᵣₘ(t), and a nuclear power output curve P_{nuclear}(t); a relationship among the conventional energy power generation output curve and the hydropower output curve, the thermal power output curve and the nuclear power output curve is as follows:
$${P}_{old} ( t ) = {P}_{hydro} ( t ) + {P}_{therm} ( t ) + {P}_{nuclear} ( t ) ;$$
S2, obtaining a wind power generation output curve P_{wind}(t) and a solar power generation output curve Pₚᵥ(t) from the power dispatching system, and obtaining a new energy power generation output curve P_{new}(t);
$${P}_{new} ( t ) = {P}_{wind} ( t ) + {P}_{pv} ( t ) ;$$
S3, performing a calculation according to the load power curve and the conventional energy power generation output curve to obtain a new energy power generation net demand curve P_{demand}(t);
$${P}_{demand} ( t ) = {P}_{load} ( t ) - {P}_{hydro} ( t ) - {P}_{therm} ( t ) - {P}_{nuclear} ( t ) ;$$
S4, calculating an optimization configuration capacity of an energy storage power station in an energy storage period and in a planning period duration according to the new energy power generation output curve and the new energy power generation net demand curve, and details are as follows:
S4-1, calculating an optimization configuration capacity E_{T}_{₁} of an energy storage power station in a first energy storage period [0, T₁];
the energy storage period is denoted as T₁, T₁ ϵ [0, tₘₐₓ] and charging and discharging behaviors are existed in the energy storage period, and a total charging duration of the energy storage station is an energy storage duration; the planning period duration is nT₁, and n is a multiple of the energy storage period:
$$\{ \begin{matrix}n = ⌊ \frac{{t}_{max}}{{T}_{1}} ⌋ \\ {nT}_{1} \leq {t}_{max}\end{matrix} ,$$
wherein a symbol [·] stands for rounding down;
letting a maximum number of intersection points between the new energy power generation net demand curve P_{demand}(t) and the new energy power generation output curve P_{new}(t) in the first energy storage period [0, T₁] be iₘₐₓ^{T}^{₁}, and time axis coordinates of the intersection points are as follows:
$${t}_{{T}_{1} , 1} , {t}_{{T}_{1} , 2} , … , {t}_{{T}_{1} , i} , … , {t}_{{T}_{1} , {i}_{max}^{{T}_{1}}} ,$$
and satisfying:
$$0 < {t}_{{T}_{1} , 1} < {t}_{{T}_{1} , 2} < … < {t}_{{T}_{1} , i} < … < {t}_{{T}_{1} , {i}_{max}^{{T}_{1}}} \leq {T}_{1}$$
wherein i represents an intersection number of two curves in the first energy storage period [0, T₁], i=(1,2, . . . , iₘₐₓ^{T}^{₁});
calculating energy storage areas of
$$\text{?} , \text{?} , … , \text{?} , … , \text{?}$$
$$\text{?} \text{indicates text missing or illegible when filed}$$
in intervals of [0, t_{T}_{₁}_{,1}],
$$[ {t}_{{T}_{1} , 1} , {t}_{{T}_{1} , 2} ] , … [ {t}_{{T}_{1} , {i}_{max} - 1} \text{?} , {t}_{{T}_{1} , {i}_{max}^{{T}_{1}}} ] and [ {t}_{{T}_{1} , {i}_{max}} \text{?} , {T}_{1} ]$$
$$\text{?} \text{indicates text missing or illegible when filed}$$
respectively:
$$\begin{matrix}{S}_{{T}_{1} , 1} = {\int }_{0}^{{t}_{{T}_{1} , 1}} ( {P}_{n e w} ( t ) - {P}_{demand} ( t ) ) dt , \\ {S}_{{T}_{1} , 2} = {\int }_{{t}_{{T}_{1} , 1}}^{{t}_{{T}_{1} , 2}} ( {P}_{n e w} ( t ) - {P}_{demand} ( t ) ) dt , \\ … , \\ \text{?} ( {P}_{n e w} ( t ) - {P}_{demand} ( t ) ) dt , \\ … , \\ \text{?} ( {P}_{n e w} ( t ) - {P}_{demand} ( t ) ) dt\end{matrix}$$
$$\text{?} \text{indicates text missing or illegible when filed}$$
and in the first energy storage period [0, T₁], ∫₀^{T}^{₁}(P_{new}(t)−P_{demand}(t)) dt≤0, indicating that the energy storage power station will complete a whole cycle of charging and discharging in the first energy storage period;
the optimization configuration capacity E_{T}_{₁}, of the energy storage power station in the first energy storage period [0, T₁;] is calculated as follows:
$${E}_{{T}_{1}} = {( - 1 )}^{α} \vert {S}_{{T}_{1} , 1} \vert + {( - 1 )}^{α} \vert {S}_{{T}_{1} , 2} \vert + … + {( - 1 )}^{α} \text{?} + … + {( - 1 )}^{α} \text{?} ,$$
$$\text{?} \text{indicates text missing or illegible when filed}$$
wherein a value of α is as follows:
$$; α = \{ \begin{matrix}0 , & if \text{?} \geq 0 \\ 1 , & if \text{?} < 0\end{matrix} \\ \text{?} \text{indicates text missing or illegible when filed}$$
S4-2, according to a method in S4-1, calculating an optimization configuration capacity E_{T}_{₂}, of an energy storage power station in a second energy storage period [T₁, 2T₁;], an optimization configuration capacity E_{T}_{₃} of an energy storage power station in a third energy storage period [2T₁, 3T₁], . . . , and an optimization configuration capacity E_{T}_{ₙ}, of an energy storage power station in an n-th energy storage period [(n−1)T₁, nT₁] in sequence; and
S4-3, calculating the optimization configuration capacity E of the energy storage power station in the planning period duration:
E=max{E_{T}_{₁}, E_{T}_{₂}, . . . , E_{T}_{ₙ}},
wherein, a symbol max{·, . . . ,·,} represents to take a maximum value;
S5, calculating an investment cost of the optimization configuration capacity of the energy storage power station according to the optimization configuration capacity E of the energy storage power station in the planning period duration: when the optimization configuration capacity of the energy storage power station in the planning period duration [0, nT₁] is E and the investment cost of a unit capacity is ϵ, the investment cost C_{cap,E} of the optimization configuration capacity of the energy storage power station is calculated according to a following formula: C_{cap,E}=E*ϵ;
S6, calculating opportunity carbon costs and energy storage power station capacity investment costs under different energy storage power station capacities in the planning period duration, and constructing an opportunity carbon cost function and an energy storage power station capacity investment cost function, and details are as follows:
S6-1, calculating an opportunity carbon cost C_{opp.T}_{₂} under an energy storage power station capacity E′ in the first energy storage period [0, T₁];
during a whole planning period duration, when the energy storage power station capacity is lower than the optimization configuration capacity of the energy storage power station, a wind power generation output and a solar power generation output are not capable of being fully absorbed by a power system, and wind power generation is abandoned and solar power generation is abandoned, and the opportunity carbon cost will generate at this time; assuming that a change value of the energy storage power station capacity relative to the optimization configuration capacity is ΔE, ΔE ϵ [0, E] the energy storage power station capacity E′ is calculated as follows:
$${E}^{′} = E - Δ E ,$$
under the energy storage power station capacity E′, an opportunity carbon cost C_{opp.T}_{₁} in the first energy storage period [0, T₁] is:
$${C}_{app , {T}_{1}} = β \vert \vert {S}_{{T}_{1} , 1} \vert - {E}^{′} \vert + β \vert \vert {S}_{{T}_{1} , 2} \vert - {E}^{′} \vert + … + β \vert \vert \text{?} \vert - {E}^{′} \vert ,$$
$$\text{?} \text{indicates text missing or illegible when filed}$$
wherein a value of β is as follows:
$$β = \{ \begin{matrix}0 , & if \text{?} \geq 0 \\ 1 , & if \text{?} < 0\end{matrix} ;$$
$$\text{?} \text{indicates text missing or illegible when filed}$$
S6-2, according to a method in S6-1, calculating an opportunity carbon cost C_{opp.T}_{₂} under an energy storage power station capacity E′ in the second energy storage period [T₁, 2T₁], an opportunity carbon cost C_{opp.T}_{₃} under an energy storage power station capacity E′ in the third energy storage period [2T₁, 3T₁], . . . and an opportunity carbon cost C_{opp.T}_{ₙ} under an energy storage power station capacity E′ in the n-th energy storage period [(n−1)T₁, nT₁] in sequence;
S6-3, calculating the opportunity carbon cost C_{opp.E′} under the energy storage power station capacity E′ in the planning period duration:
$${C}_{opp , {E}^{′}} = ( {C}_{app , {T}_{1}} + {C}_{opp , {T}_{2}} + … + {C}_{opp , {T}_{n}} ) * ε ,$$
wherein ε is a carbon price corresponding to a unit electric quantity;
S6-4, calculating the investment cost C_{cap.E′}:C_{cap.E′}=E′·ϵ under the energy storage power station capacity E′; and
S6-5, changing ΔE to obtain opportunity carbon costs Cₒₚₚ and energy storage power station capacity investment costs C_{cap} under different energy storage power station capacities E″, and then obtaining an opportunity carbon cost function and an energy storage power station capacity investment cost function under different energy storage power station capacities E″ in the planning period duration:
f(E″): E″ → Cₒₚₚ,
g(E″): E″ → C_{cap},
wherein f(E″) is the opportunity carbon cost function under different energy storage power station capacities E″, g(E″) is the energy storage power station capacity investment cost function under different energy storage power station capacities E″, and a symbol → represents a functional mapping relationship between the energy storage power station capacities E″ and the opportunity carbon costs Cₒₚₚ or the energy storage power station capacity investment costs C_{cap} under different energy storage power station capacities E″;
S7, constructing a multi-objective energy storage power station capacity optimization configuration model according to the opportunity carbon cost function and the energy storage power station capacity investment cost function under different energy storage power station capacities E″ in the planning period duration, and calculating a multi-objective Pareto optimization set;
the multi-objective energy storage power station capacity optimization configuration model is as follows:
min {f(E″),g(E″)}
s.t. f(E″)≤Cₒₚₚ^{max}
g(E″)≤C_{cap}^{max},
wherein min {·,·} represents a minimization of the opportunity carbon cost function f(E″) and the energy storage power station capacity investment cost function g(E″), s.t. represents constraint conditions, Cₒₚₚ^{max} and C_{cap}^{max} represent a maximum of the opportunity carbon cost and a maximum of an energy storage power station capacity investment cost respectively; because f(E″) and g(E″) are mutually exclusive targets, a calculation result is a multi-objective Pareto optimization set Pₐᵣₑₜₒ;
the multi-objective Pareto optimization set is obtained by using multi-objective optimization algorithms:
Pₐᵣₑₜₒ={E′_{opt.1}, E′_{opt.2}, . . . , E′_{opt.j}, . . . , E′_{opt.j}_{ₘₐₓ}},
wherein j is an element number in Pₐᵣₑₜₒ, jₘₐₓ is a maximum number of elements in Pₐᵣₑₜₒ, and E_{′opt.j} is a j-th element, namely a j-th energy storage power station multi-objective optimization capacity value in Pₐᵣₑₜₒ; and
S8, determining weights of elements in the multi-objective Pareto optimization set Pₐᵣₑₜₒ according to a fuzzy set function, and outputting an energy storage power station multi-objective optimization capacity value in order according to the weights from large to small; this result provides a decision support for an energy storage power station capacity optimization configuration; the fuzzy set function is defined as follows:
$${η}_{f} ( {E}_{opt , j}^{′} ) = \{ \begin{matrix}0 , & f ( {E}_{opt , j}^{′} ) \leq {γ}_{f} \\ \frac{f ( {E}_{opt , j}^{′} ) - {γ}_{f}}{{ρ}_{f} - {γ}_{f}} , & {γ}_{f} < f ( {E}_{opt , j}^{′} ) < {ρ}_{f} \\ 1 , & f ( {E}_{opt , j}^{′} ) \geq {ρ}_{f}\end{matrix}$$
$${η}_{g} ( {E}_{opt , j}^{′} ) = \{ \begin{matrix}0 , & g ( {E}_{opt , j}^{′} ) \leq {γ}_{g} \\ \frac{g ( {E}_{opt , j}^{′} ) - {γ}_{g}}{{ρ}_{g} - {γ}_{g}} , & {γ}_{g} < g ( {E}_{opt , j}^{′} ) < {ρ}_{g} \\ 1 , & g ( {E}_{opt , j}^{′} ) \geq {ρ}_{g}\end{matrix} ,$$
wherein ρ_{f} and γ_{f} are upper and lower limits of opportunity carbon cost thresholds respectively, and values of ρ_{f} and γ_{f} are determined by energy storage power station capacity optimization configurators according to opportunity carbon cost requirements, and γ_{f}<ρ_{f}, ρ_{g} and γ_{g} are upper and lower limits of energy storage power station capacity investment cost thresholds respectively, and values of ρ_{g} and γ_{g} are determined by the energy storage power station capacity optimization configurators according to capacity investment cost requirements, and γ_{g}<ρ_{g}, η_{f}(E′_{opt.j}) is a fuzzy set function of the opportunity carbon cost of a j-th element E′_{opt.j} in the Pₐᵣₑₜₒ, and η_{g}(E′_{opt.j}) is a fuzzy set function of the energy storage power station capacity investment cost of the j-th element E′_{opt.j} in the Pₐᵣₑₜₒ;
a weight ηⱼ of the j-th element E′_{opt.j} in the Pₐᵣₑₜₒ is calculated according to a following formula:
$${η}_{j} = \frac{{η}_{f} ( {E}_{opt , j}^{′} ) + {η}_{g} ( {E}_{opt , j}^{′} )}{{\sum }_{j = 1}^{{j}_{max}} ( {η}_{f} ( {E}_{opt , j}^{′} ) + {η}_{g} ( {E}_{opt , j}^{′} ) )} ,$$
according to the weight ηⱼ, the energy storage power station multi-objective optimization capacity value is output in order from large to small, and this result provides the decision support for the energy storage power station capacity optimization configuration.

2. The method for the energy storage power station capacity optimization configuration adapting to the variable energy storage period according to claim 1, wherein in the S4-3, the energy storage period T₁ is set to different values according to the energy storage duration, so as to obtain the optimization configuration capacity of the energy storage power station adapting to different energy storage durations or periods.

3. The method for the energy storage power station capacity optimization configuration adapting to the variable energy storage period according to claim 1, wherein in the S7, the multi-objective optimization algorithms comprise a multi-objective gradient descent algorithm, an strength Pareto evolutionary algorithm, a multi-objective evolutionary algorithm based on a decomposition, and a non-dominated sorting genetic algorithm.

4. The method for the energy storage power station capacity optimization configuration adapting to the variable energy storage period according to claim 1, wherein in the S8, values of η_{f}(E′_{opt.j}) and ηg(E′_{opt.j}) are both between 0 and 1.

5. A system for the energy storage power station capacity multi-objective optimization configuration adapting to the variable energy storage period based on the method of claim 1, comprising a basic data extraction module, a new energy power generation net demand curve generation module, an energy storage power station capacity optimization configuration model construction module, an energy storage power station capacity optimization configuration model solving module and a system output module;
the basic data extraction module is used for obtaining the load power curve, the conventional energy power generation output curve, the wind power generation output curve and the solar power generation output curve from the power dispatching system, wherein the conventional energy power generation output curve comprises the hydropower output curve, the thermal power output curve and the nuclear power output curve;
the new energy power generation net demand curve generation module is used for performing a calculation according to the load power curve and the conventional energy power generation output curve to obtain the new energy power generation net demand curve;
the energy storage power station capacity optimization configuration model construction module is used for calculating the optimization configuration capacity and the investment cost of the energy storage power station in the energy storage period and the planning period duration according to the new energy power generation output curve and the new energy power generation net demand curve; calculating the opportunity carbon costs and the energy storage power station capacity investment costs under different energy storage power station capacities in the planning period duration; constructing the opportunity carbon cost function and the energy storage power station capacity investment cost function; and constructing the multi-objective energy storage power station capacity optimization configuration model;
the energy storage power station capacity optimization configuration model solving module is used for solving the multi-objective energy storage power station capacity optimization configuration model and performing a calculation to obtain the multi-objective Pareto optimization set, and solving methods are the multi-objective optimization algorithms; and
the system output module is used for determining the weights of the elements in the multi-objective Pareto optimization set according to the fuzzy set function, and then sequentially outputting energy storage power station capacity optimization configuration results according to the weights in order from large to small.

6. The system for the energy storage power station capacity multi-objective optimization configuration adapting to the variable energy storage period according to claim 5, wherein each module in the multi-objective optimization configuration system of the energy storage power station capacity adapting to the variable energy storage period is capable of being realized by softwares, hardwares and combinations thereof in whole or in part.

7. The system for the energy storage power station capacity multi-objective optimization configuration adapting to the variable energy storage period according to claim 5, wherein each module is capable of being embedded in or independent of a processor in a computer device in a hardware form, or is capable of being stored in a memory in the computer device in a software form, so as to facilitate the processor to call and execute operations corresponding to all the modules.
